(19) United States
(12) Patent Application Publication
(10) Pub. No.: US 2018/0249461 A1
(43) Pub. Date: Aug. 30, 2018

(54) METHODS AND APPARATUSES TO FORM SELF-ORGANIZED MULTI-HOP MILLIMETER WAVE BACKHAUL LINKS

(71) Applicant: Intel IP Corporation, Santa Clara, CA (US)

(72) Inventors: Honglei Miao, Munich (DE); Michael Faerber, Wolfratshausen (DE)

(21) Appl. No.: 15/513,116

(22) PCT Filed: Oct. 21, 2015
(86) PCT No.: PCT/US2015/056758

§ 371 Date: Mar. 21, 2017

Related U.S. Application Data
(60) Provisional application No. 62/066,787, filed on Oct. 21, 2014.
(60) Provisional application No. 62/067,179, filed on Oct. 22, 2014.

(51) Int. Cl. H04W 72/04; H04W 48/16; H04W 24/10; H04B 7/155; H04B 7/06

(52) U.S. Cl. CPC H04W 72/0426; H04W 48/16; H04W 24/10; H04W 84/045; H04B 7/15507; H04B 7/15542; H04B 7/0617; H04W 72/046

(57) ABSTRACT

Embodiments of the present disclosure describe systems, devices, and methods for self-organized multi-hop millimeter wave backhaul links. Various embodiments may include a relay node receiving discovery signal information from an eNB and measuring millimeter wave discovery signals of other relay nodes based on the information. Measurements may be fed back to the eNB and used to create a millimeter wave backhaul link. Other embodiments may be described or claimed.

### CROSS-REFERENCE TO RELATED APPLICATION

This application claims priority to U.S. Patent Application No. 62/066,787 filed Oct. 21, 2014 and U.S. Patent Application No. 62/067,179 filed Oct. 22, 2014, both entitled “Self-Organized Multi-Hop Millimeter Wave Backhauling to Support Dynamic Routing and Cooperative Transmission.”

### FIELD

Embodiments of the present disclosure generally relate to the field of wireless communication, and more particularly, to methods and apparatuses for multi-hop millimeter-wave backhaul support.

### BACKGROUND

Millimeter-wave (mmWave) communication has been considered as a promising technique to fulfill prospective requirements of 5G mobile systems. Typically, mmWave communications occur in an extremely high-frequency (EHF) band that includes frequencies from 30 to 300 gigahertz (GHz).

Adopting mmWave communications for backhaul link connection between base stations has also drawn significant research interests in both academic and industry arenas. Two primary technical benefits are envisioned for the employment of mmWave communication. The first benefit is the provision of huge bandwidth to support a very high data rate of multiple gigabits per second with low latency. The second benefit is that good spatial separation between different links may be used to address propagation path loss. This will potentially increase the spatial reuse factor which turns into higher area spectrum efficiency. For instance, the signals to different links (or user equipments (UEs)) with distinct beam directions, which may be referred to as pencil beams, in some instances, may have limited mutual interference among each other. As such, the same frequency resource can be allocated to different links/UEs at the same time so as to increase the spectrum efficiency by spatial domain multiple access (SDMA) technique.

The primary challenge of adopting mmWave spectrum in the practical system is due to propagation loss caused by very high radio frequency. Hence, the typical coverage of an mmWave link is clearly shorter than that in the conventional mobile broadband spectrum below 6 GHz used in Long Term Evoluation (LTE) or other legacy systems.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates a communication environment in accordance with some embodiments.

FIG. 2 illustrates discovery signal structures in accordance with some embodiments.

FIGS. 3-5 illustrate phases of a backhaul link establishment procedure in accordance with some embodiments.

FIG. 6 illustrates a computing apparatus in accordance with some embodiments.

FIG. 7 illustrates a system in accordance with some embodiments.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in some embodiments” is used repeatedly. The phrase generally does not refer to the same embodiments; however, it may. The terms “comprising,” “having,” and “including” are synonymous, unless the context dictates otherwise.

The phrases “A or B,” “A/B,” and “A and/or B” mean (A), (B), or (A and B).

As used herein, the term “circuitry” refers to, is part of, or includes hardware components such as an application specific integrated circuit (ASIC), an electronic circuit, a logic circuit, a processor (shared, dedicated, or group) and/or memory (shared, dedicated, or group) that are configured to provide the described operations. In some embodiments, the circuitry may execute one or more software or firmware programs to provide at least some of the described operations. In some embodiments, the circuitry may be implemented in, or operations associated with the circuitry may be implemented by, one or more software or firmware modules. In some embodiments, circuitry may include logic, at least partially operable in hardware, to perform the described operations.

As described above, a challenge of adopting mmWave spectrum may be related to limited coverage of an mmWave link. To provide sufficient backhaul link coverage, multi-hop relay backhauling may be used. This may result in a chain of multiple point-to-point (hop 1) links being used as a backhaul link from a target mmWave small cell base station to an anchor evolved node B (eNB) that connects the access network to a core network.

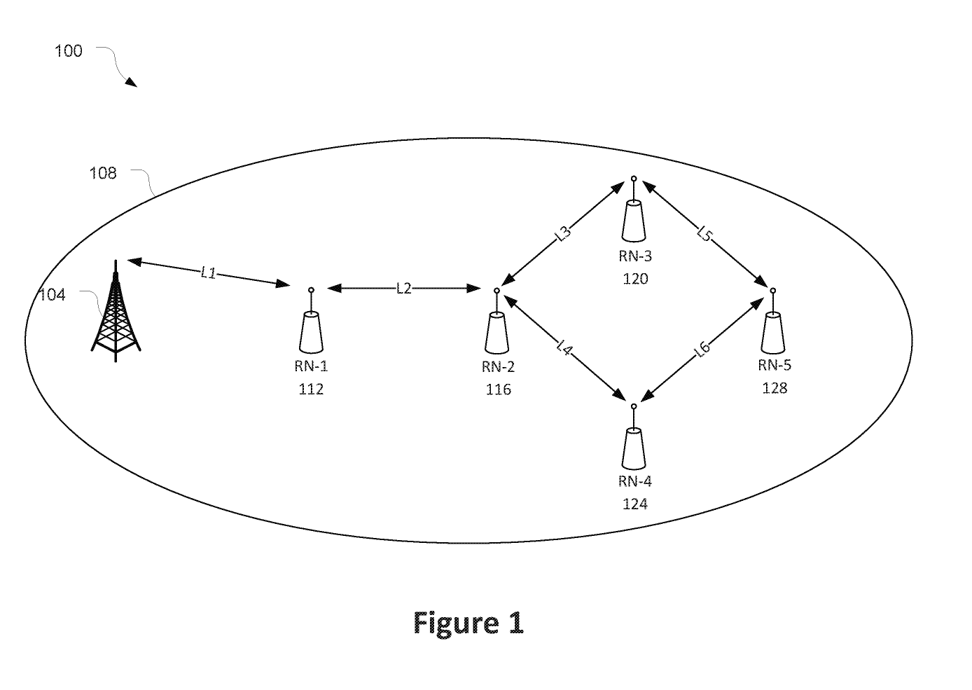

FIG. 1 schematically illustrates a communication environment 100 in accordance with various embodiments. The communication environment 100 may include an anchor eNB 104 having a macrocell coverage area 108 of broadband spectrum. The communication environment 100 may also include five relay nodes (RNs) that are disposed in the macrocell coverage area 108, for example, RN-1 112, RN-2 116, RN-3 120, RN-4 124, and RN-5 128. At least one of the functions of the relay nodes may be to establish an mmWave backhaul connection to the eNB 104.

The eNB 104 and the relay nodes may be equipped with mmWave radio access technology (RAT) interfaces to communicate over mmWave communication links. The mmWave communication links (or simply mmWave links) are illustrated in FIG. 1 by the arrow lines with respective labels Ly, where y=1, 2, . . . 6.

A particular multi-hop backhaul link may be composed of a number of mmWave links. For example, a backhaul link between RN-5 128 and eNB 104 may be composed of L1, L2, L3, and L5, which may be referred to as path 1 (P1), or of L1, L2, L4, and L6, which may be referred to as path 2 (P2). The multi-hop backhaul link may be used for routing uplink traffic, for example, traffic from the RN-5 128 to the eNB 104, or for routing down link traffic, for example, traffic from the eNB 104 to the RN-5 128.

To reduce the initial installation effort, the backhaul link is desired to be established in a self-organized manner with minimum human interaction. To improve the network power efficiency, it is envisioned that certain relay nodes may be dynamically switched on and off depending on the traffic needs. Moreover, in some cases, to improve the link reliability, dynamic path switching or cooperative backhaul transmission is also foreseen to be beneficial. Thus, embodiments of the present disclosure provide a self-organized backhaul link establishment scheme with support for flexible dynamic path switching and possible cooperative transmission and/or reception.

This disclosure provides signaling methods to facilitate the above-mentioned self-organized multi-hop mmWave backhaul link establishment. Furthermore, the dynamic path switching and cooperative transmission can be flexibly supported in a transparent manner with respect to a target relay node.

A relay node as described herein may provide backhaul support and, in some embodiments, may also be equipped to provide radio access to users through a small cell, e.g., a cell associated with a coverage area that is less than coverage area 108. The small cell provided by a relay node may be an mmWave user access cell or a mobile broadband user access cell, for example, a 3^{rd} Generation Partnership Project (3GPP) Long Term Evolution (LTE) user access cell.

The eNB 104 may establish a radio resource control (RRC) connection with the RN-5 128 using an existing LTE procedure. The RRC connection may be established over a direct radio link between the eNB 104 and the RN-5 128 that is in mobile broadband spectrum, for example, frequencies below approximately 6 GHz.

The eNB 104 may serve as a primary cell (PCell) for newly camped mmWave relay nodes such as, for example, RN-5 128. The eNB 104 may transmit discovery information to the newly camped nodes such as RN-5 128 to provide information as to how the newly camped nodes are to receive discovery signals transmitted by other relay nodes, for example, RN-3 120 and RN-4 124 in FIG. 1. As used herein, a newly camped relay node may be an mmWave relay node that is RRC connected with a macrocell eNB, but is not yet linked with other mmWave relay nodes.

The RN-5 128 may use the discovery information provided by the eNB 104 to search, detect, and measure discovery signals transmitted by other relay nodes, for example, RN-3 120 and RN-4 124. In some embodiments, the discovery signals may be measured for receive power or quality metrics. After measuring the discovery signals, the RN-5 128 may transmit a discovery signal report to the eNB 104 through the PCell.

The eNB 104 may use the reported power or quality metrics to select one or more relay nodes to provide one or more corresponding secondary cells (SCells) for the RN-5 128. Afterwards, the RN-5 128 may monitor backhaul link traffic on both the PCell, provided by the eNB 104, and the one or more SCells, provided by one or more relay nodes.

The RN-5 128 may transmit a capability message to the eNB 104 that indicates a number of parallel discovery signals that the RN-5 128 is capable of transmitting. The message may additionally/alternatively indicate a number of sequential mmWave discovery signals that may be transmitted in a discovery cluster. The capability message may be transmitted to the eNB 104 through the PCell.

Upon receiving the capability message from the RN-5 128, the eNB 104 may configure and transmit an indication of discovery signal configuration information to the RN-5 128 through the PCell. The discovery signal configuration information may include, for example, discovery occasions and sequence identifiers. The discovery signal configuration information may be transmitted in a configuration message.

Upon receiving the configuration message, the RN-5 128 may start to transmit one or more discovery signals based on the discovery signal configuration information. This may allow other relay nodes in camping mode to detect the RN-5 128 for additional mmWave connections.

In some embodiments, all the relay nodes in the coverage area 108 may report receive power or quality of detected discovery signals to the eNB 104. The reports may be transmitted through respective PCells or SCells. In some embodiments, the reports may be transmitted by the relay nodes based on a periodic reporting event, for example, expiration of a periodic reporting timer, or based on a request from the eNB 104.

The eNB 104 may use the information fed back from each of the relay nodes to reconfigure the mmWave SCells and discovery signal configurations to each relay node to update a backhaul link topology or enable advanced cooperative operation.

Embodiments described enable the establishment of a self-organized, multi-hop mmWave backhaul link with automatic beam alignment by virtue of the measurement of directional discovery signals. The dynamic path switching and cooperative transmission for the backhaul link may be fully controlled by the eNB 104, which may have overall knowledge about the mmWave links in the network. Further, configuration or reconfiguration of the backhaul link may be performed through an established PCell, which may be more robust than the mmWave-based SCells. This may ensure a better user experience.

The discovery signals transmitted by the relay nodes may be performed on a periodic basis. These discovery signals may be implemented by signal sequences that have desirable auto-correlation properties, for example, Zadoff-Chu sequence in the LTE system, to aid the discovery signal detection.

Given transmit power limits and targeted beamforming gain, a relay node may transmit one or several parallel radio-frequency (RF) beams at the same time. Let n_{b}∈{1,2, . . . , N_{b}} define a number of parallel RF beams supported by a relay node. The relay node may transmit n_{b} discovery signals using the same time and frequency resources with different sequence signatures, which may be a function of sequence identifier, and beam directions.

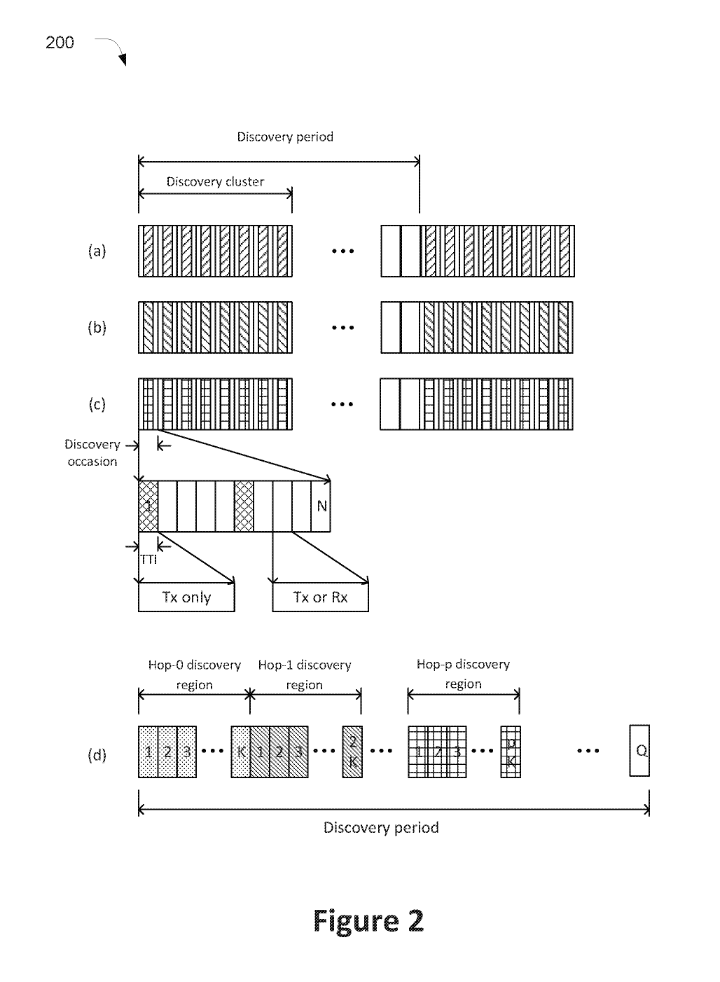

FIG. 2 illustrates three discovery signals that may be transmitted by relay node in respective RF beams at the same time in accordance with some embodiments. The three discovery signals, shown as (a), (b), and (c) in FIG. 2, may be transmitted at the same time with each discovery signal using a respective signal sequence signature. As shown in FIG. 2, each of these discovery signals may include a discovery cluster transmitted periodically with the same period of n_{D} frames, for example, 80 ms, 160 ms, or longer. Each discovery cluster may include n_{O} discovery occasions, with each discovery occasion being comprised of N transmit time intervals (TTIs). One or several TTIs may be reserved for transmit (Tx) only in order to transmit discovery signals.

A discovery signal in each discovery occasion of a discovery cluster may be transmitted with different beam directions and, therefore, beam scanning may be performed by the same physical RF beamformer.

In one embodiment, a relay node, for example, RN-5 128, may include three antenna arrays, each of which may be driven by its own RF beam former and may serve a sector of 120°. Assuming n_{O}=8, each sector may be spanned by 8 beam directions (one for each discovery occasion) with a beam direction spacing of 15° in the time period of one discovery cluster. If one TTI is 100 μs, and one discovery occasion includes 10 TTIs, discovery signals may be transmitted over one sector in 8 ms.

To support a multi-hop backhaul link, each relay node may be capable of receiving and tracking a discovery signal from an upstream relay node and transmitting its own discovery signal for a downstream relay node or its served UEs. To avoid the need of transmitting and receiving simultaneously (and, thus, requiring full-duplex transmission structures), the relay nodes at different hops may transmit discovery signals at different times.

To facilitate the transmission of discovery signals at different times, p discovery regions may be defined at the beginning of each discovery period as shown in (d) of FIG. 2. Each discovery region may include K discovery occasions. Different relay nodes may have different discovery signal capabilities and, therefore, need different numbers of discovery occasions to transmit discovery signals within a discovery cluster. Therefore, K may be selected to accommodate the anticipated maximum number of discovery occasions needed. In most instances, K may be greater than n₀, although K may also equal n₀.

Referring again to FIG. 1, the eNB 104 may use its mmWave radio to transmit discovery signal in the hop-0 discovery region; RN-1 112 and RN-2 116 may transmit discovery signals in hop-1 and hop-2 discovery regions, respectively; and RN-3 120 and RN-4 124 may transmit discovery signals in hop-3 discovery region.

In other embodiments, only two discovery regions may be used. The first discovery region may be used for relay nodes transmitting discovery signals at an even number hop location with respect to the anchor eNB, for example, eNB 104 and RN-2 116. The second discovery region may be used for relay nodes transmitting discovery signals at an odd-numbered hop location with respect to the anchor eNB, for example, RN-1 112, RN-3 120, and RN-4 124.

In some embodiments, the discovery signals of the relay nodes may be synchronous with PCell signals by ensuring a frame boundary and discovery period boundary of the SCells are aligned with corresponding boundaries in the PCell. This may allow the PCell to assist with relay node discovery. This may be done by the eNB 104 or the relay nodes performing a boundary alignment process periodically, or when it is determined that the boundaries have become misaligned.

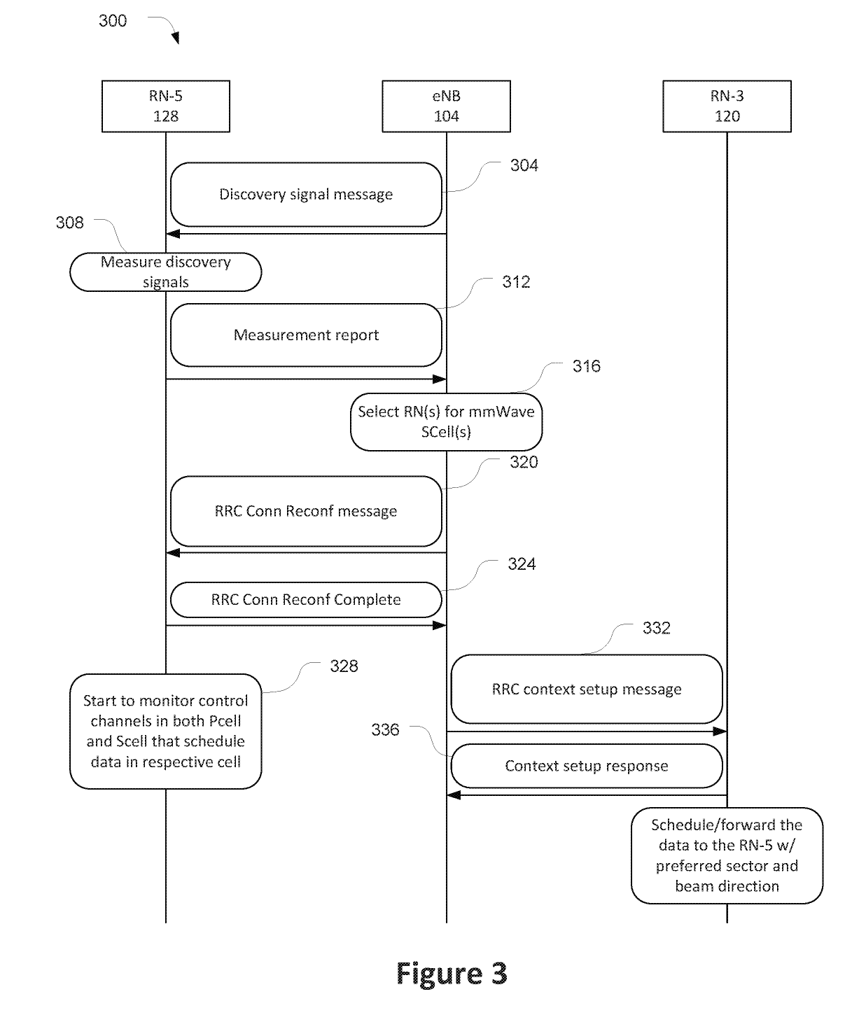

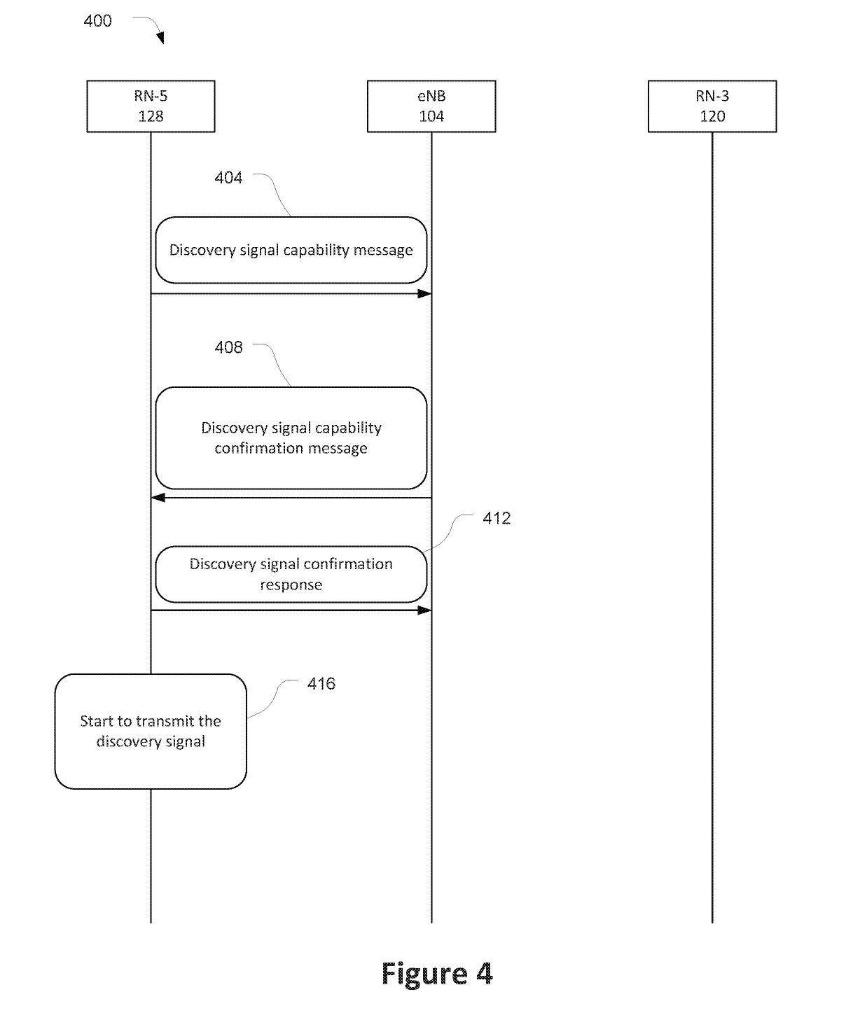

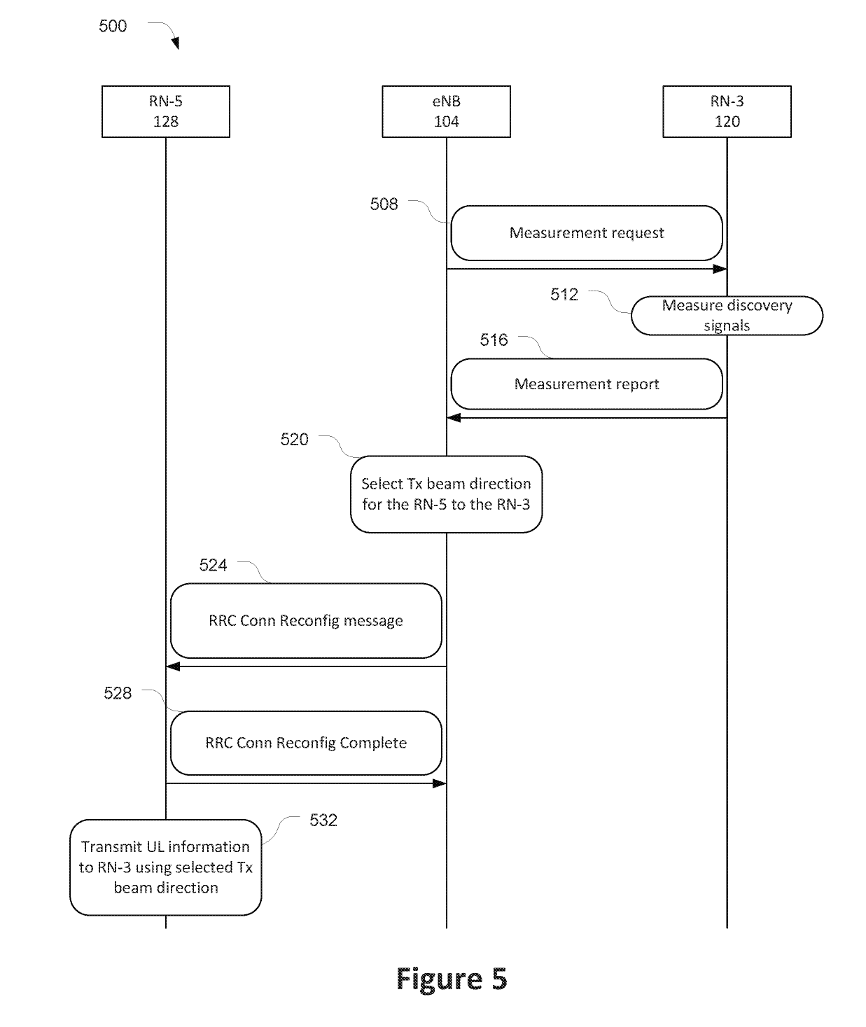

FIGS. 3-5 respectively illustrate phases 1-3 of an mmWave backhaul link establishment procedure in accordance with some embodiments. In particular, FIG. 3 illustrates a downlink alignment (or “first”) phase 300 of the mmWave backhaul link establishment procedure; FIG. 4 illustrates a discovery signal configuration (or “second”) phase 400 of the mmWave backhaul link establishment procedure; and FIG. 5 illustrates an uplink beam alignment (or “third”) phase 500 of the mmWave backhaul link establishment procedure in accordance with some embodiments. The phases of the mmWave backhaul link establishment procedure may be initiated after an anchor node, for example, the eNB 104, establishes an RRC connection with a target relay node, for example, the RN-5 128.

While phases 300, 400, and 500, are referred to as first, second, and third phases, this does not imply an ordered occurrence of these phases in all instances. For example, in some embodiments some of the phases may be done independent of the other phases, for example, the third phase may be performed more frequently than the first and second phases.

Referring first to the downlink alignment phase 300 illustrated in FIG. 3, at 304, the eNB 104 may transmit a discovery signal message to the RN-5 128. The discovery signal message may include configuration information of mmWave discovery signals that may be transmitted by other relay nodes in the coverage area 108. The eNB 104 may have knowledge of the discovery signal configurations of the other relay nodes in coverage area 108 due to respective PCell connections with each of the other relay nodes. The configuration information may include, for example, the starting time position of each discovery cluster, a number of discovery occasions in each discovery cluster, and a periodicity of the discovery cluster for mmWave discovery signals transmitted by each of the other relay nodes in the coverage area 108. The discovery signal message may also include a request, which may be explicit or implicit, for measurement information corresponding to the mmWave discovery signals.

The RN-5 128 may, at 308, use the configuration information in the discovery signal message to measure metrics of mmWave discovery signals. The RN-5 128 may turn on its mmWave receiver during those time periods with a possible presence of mmWave discovery signals and, when detected, measure various metrics of the discovery signals. In some embodiments, the measured metrics may include, but are not limited to, reference signal received power (RSRP) and reference signal received quality (RSRQ). The detected mmWave discovery signal may be identified by a sequence identifier and a discovery occasion index within a discovery cluster. The sequence identifier may identify which of a number of parallel discovery signals transmitted by a relay node is being measured and the discovery occasion index may identify the particular beam used to transmit the detected discovery signal.

The RN-5 128 may, at 312, transmit a measurement report to the eNB 104. The measurement report 312 may include, for each detected discovery signal, indications of sequence and beam identifiers and the measured metrics. In some embodiments, the RN-5 128 may only report information for a discovery signal if its corresponding measured metrics are over a threshold. The threshold may be pre-configured by the eNB 104, determined by the RN-5 128, or otherwise predetermined.

At 316, the eNB 104 may select one or more relay nodes for one or more corresponding mmWave SCells to serve the RN-5 128. The relay nodes that are selected to provide mmWave SCell's for the RN-5 128 may be selected based on the measured metrics of their discovery signals. In the described embodiments, the relay node selected to provide an mmWave SCell for the RN-5 128 may be RN-3 120. In some embodiments, such as the one presently described, only one mmWave SCell may be selected. In other embodiments, some of which are described in further detail below, more than one relay node/mmWave SCell may be selected.

At 320, the eNB 104 may transmit an RRC connection reconfiguration message. The RRC connection reconfiguration message may include information to configure the mmWave SCell provided by the RN-3 120. In some embodiments, the information may include defined transmit/receive TTI configurations of the mmWave SCell provided by the RN-3 120. The TTI configurations of the mmWave SCell provided by the RN-3 120 may indicate the TTIs the RN-3 120 transmits and/or receives information.

As described above, the RN-5 128 may use mmWave radio access technology (RAT) for both an access link and a backhaul link. Thus, in some embodiments time domain duplex for the mmWave relay nodes Tx/Rx may be adopted. As such, the Tx/Rx TTI configurations for adjacent relay nodes with established communication paths would complement each other. For example, a Tx TTI of RN-3 120 may correspond to an Rx TTI of RN-5 128 in FIG. 1. Such complementary Tx/Rr TTI configurations may allow the same air interface to be used for both the backhaul link and the access link. For example, an mmWave-Uu interface may be used for both backhaul link and access link, in contrast to LTE in-band relay where Uu and Un interfaces may be used for access link and backhaul link, respectively.

At 324, the RN-5 128 may transmit an RRC connection reconfiguration complete message to the eNB 104 to indicate successful setup of the mmWave SCell.

Following 324, the RN-5 128 may, at 328, start to monitor control channels in both PCell and SCell that scheduled data in respective cells.

At 332, the eNB 104 may transmit an RRC context setup message to the RN-3 120. The RRC context setup message may include an RRC context of the RN-5 128 including, for example, an identity of the RN-5 128 and its preferred beam directions. Preferred beam directions may be indicated by identifying a discovery occasion (using, for example, beam ID or discovery occasion index) and sector (using, for example, sequence ID).

At 336, the RN-3 120 may transmit a context setup response to the eNB 104. The context setup response may provide an indication that the context of the RN-5 128 is successfully received by the RN-3 120.

Following 336, the RN-3 120 may schedule and forward data to the RN-5 128 through the SCell using the preferred sector and beam direction.

While the first phase 300 is described as configuring one SCell for the RN-5 128, other embodiments may configure more than one SCell. For example, in some embodiments dynamic path switching may be enabled by the eNB 104 configuring both RN-3 120 and RN-4 124 to provide SCells for RN-5 128. Then, in a particular backhaul link TTI, the backhaul link packet to the RN-5 128 may be routed from either RN-3 120 or RN-4 124 depending on a routing decision made by the eNB 104 based on certain criteria. By doing so, dynamic path switching or routing may be implemented without backhaul link reconfiguration and may also be transparent to the target/destination relay node, for example, RN-5 128. Additionally, when both RN-3 120 and RN-4 124 are configured as upstream relay nodes for the RN-5 128, it may also enable cooperative transmission/reception operation for the backhaul link. Cooperative transmission may occur in the downlink when, for example, both RN-3 120 and RN-4 124 transmit the same information to the RN-5 128. Cooperative reception may occur in the uplink when, for example, the RN-5 128 transmits information to both RN-3 120 and RN-4 124.

In some embodiments, the discovery signal configuration phase 400 may follow the downlink alignment phase 300. The discovery signal configuration phase 400 may be used to configure discovery signals that are to be transmitted by the RN-5 128.

At 404, the RN-5 128 may transmit a discovery signal capability message to the eNB 104. The discovery signal capability message may include an indication of a number of parallel and sequential mmWave discovery signals that the RN-5 128 is capable of transmitting.

At 408, the eNB 104 may transmit a discovery signal capability confirmation message to the RN-5 128. In some embodiments, the discovery signal capability confirmation message may include an indication of the hop number associated with the RN-5 128. This hop number may be used by the RN-5 128 to determine in which discovery cluster of a discovery period the RN-5 128 is to transmit its discovery signals. For example, the discovery signal capability confirmation message may indicate that the RN-5 128 is associated with hop 3. Thus, the RN-5 128 may transmit its discovery signals in the discovery cluster that resides in the hop-3 discovery region.

At 412, the RN-5 128 may transmit a discovery signal confirmation response to the eNB 104. The discovery signal confirmation response may indicate that the RN-5 128 had successfully received the configuration information transmitted at 408.

At 416, the RN-5 128 may start to transmit the discovery signal. The discovery signal transmitted by the RN-5 128 may be used by other relay nodes for uplink beam alignment (as described in further detail with reference to FIG. 5), identifying possible backhaul routes by newly camped relay nodes, or by UEs that are to use mmWave RAT as a user-access mechanism.

In some embodiments, the uplink beam alignment phase 500 may follow the discovery signal configuration phase 400. The uplink beam alignment phase 500 may be used to increase the efficiency of uplink communications transmitted from the RN-5 128 to the RN-3 120.

At 508, the eNB 104 may transmit a measurement request to the RN-3 120 to request measurement information corresponding to a discovery signal of the RN-5 128.

At 512, the RN-3 may measure the discovery signals transmitted by the RN-5 128 and record various metrics as discussed above. The measured metrics may include, but are not limited to, RSRP and RSRQ.

At 516, the RN-3 120 may transmit a measurement report to the eNB 104. The measurement report may include the measurement metrics and corresponding sequence and beam identifiers.

At 520, the eNB 104 may select an uplink transmit beam direction based on the measurement report. The uplink transmit beam direction may be the direction the eNB determines is the most efficient for transmitting uplink information through the multi-hop backhaul from the RN-5 128 to the RN-3 120.

At 524, the eNB 104 may transmit an RRC connection reconfiguration message to the RN-5 128. The RRC connection reconfiguration message may include an indication of the transmit beam direction that the RN-5 128 should use for transmitting information to RN-3 120.

At 528, the RN-5 128 may send an RRC connection reconfiguration complete message to the eNB 104. The RRC connection reconfiguration complete message may confirm that the RN-5 128 has received and successfully processed the information in the RRC connection reconfiguration message.

At 532, the RN-5 128 may transmit uplink information to the RN-3 120 using the selected transmit beam direction indicated in the RRC connection reconfiguration message.

Discovery signal measurements, such as those in 512, may be done periodically with the measurement results being regularly reported to the eNB 104. This may enable beam tracking to ensure that the uplink information is transmitted in an efficient manner. A similar process may also be enabled for downlink transmissions.

In some instances, the multi-hop backhaul link path may be changed. For example, for the sake of load balancing or improved power saving, the eNB 104 in FIG. 1 may decide to switch the backhaul link of the RN-5 128 from P1 to P2. To do this, the eNB 104 may change the SCell configuration for the RN-5 128 from RN-3 120 to RN-4 124. In this case, the first phase 300 and the third phase 500 may be performed by substituting RN-4 124 for RN-3 120 to achieve downlink and uplink beam alignment for the new backhaul link L6.

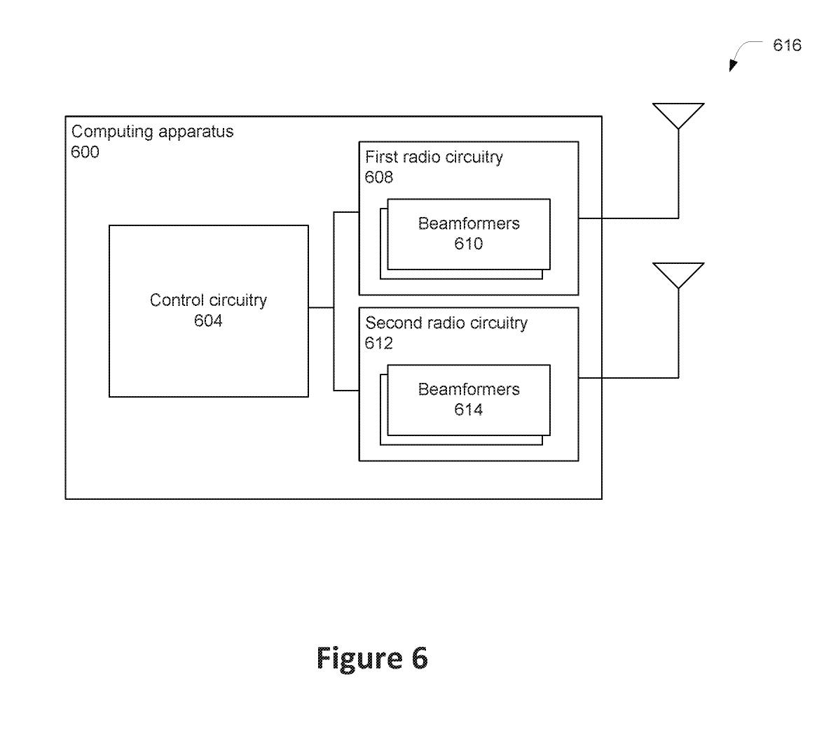

FIG. 6 illustrates a computing apparatus 600 that may represent a relay node or eNB in accordance with various embodiments. In embodiments, the computing apparatus 600 may include control circuitry 604 coupled with first radio circuitry 608 and second radio circuitry 612. The first radio circuitry 608 and the second radio circuitry 612 may be coupled with one or more antennas 616.

The first radio circuitry 608 may include a radio transceiver that is to operate in a mobile broadband spectrum. For example, the first radio circuitry 608 may include radio transmit/receive circuitry that is configured to transmit/receive RF signals having frequencies less than approximately 6 GHz. The first radio circuitry 608 may include one or more beamformers 610 that, in conjunction with the one or more antennas 616, may provide directed and, possibly, dynamically configurable, reception/transmission of the RF signals.

The second radio circuitry 612 may include a radio transceiver that is to operate in an mmWave spectrum. For example, the second radio circuitry 612 may include radio transmit/receive circuitry that is configured to transmit/receive RF signals having frequencies above 6 GHz and, in some embodiments, between approximately 30 and 300 GHz. The second radio circuitry 612 may include one or more beamformers 614 that, in conjunction with the one or more antennas 616, may provide directed and, possibly, dynamically configurable, reception/transmission of the RF signals.

Referring again to the example discussed above with respect to FIG. 2, the second radio circuitry 612 may include three beamformers 614. Each of the beamformers 614 may serve a 120° sector. To transmit mmWave discovery signals in a corresponding sector, each beamformer 614 may be capable of operating with a beam direction spacing of 15°. Therefore, eight discovery signals may be transmitted in eight discovery occasions of a discovery cluster with each of the eight discovery signals being transmitted in a different beam direction. Other embodiments may include second radio circuitry 612 having other discovery signal capabilities. Indications of these discovery signal capabilities may be transmitted to the eNB in message 404 as described above with respect to FIG. 4.

The control circuitry 604 may control operations of the first radio circuitry 608 and the second radio circuitry 612 to perform operations similar to those described elsewhere in this disclosure. For example, the control circuitry 604 may, in conjunction with the first radio circuitry 608 and the second radio circuitry 612, perform the operations of the eNB 104, RN-5 128, or RN-3 120 described above in phases 1-3 of the mmWave backhaul link establishment procedure. In general, the control circuitry 604 may control the first radio circuitry 608 and the second radio circuitry 612 to transmit/receive the messages described herein over the appropriate radio interfaces. The control circuitry 604 may perform higher-layer operations such as, for example, generating the messages that are to be transmitted, processing the messages that are received, selecting relay nodes to provide mmWave SCells, scheduling and transmitting data, etc.

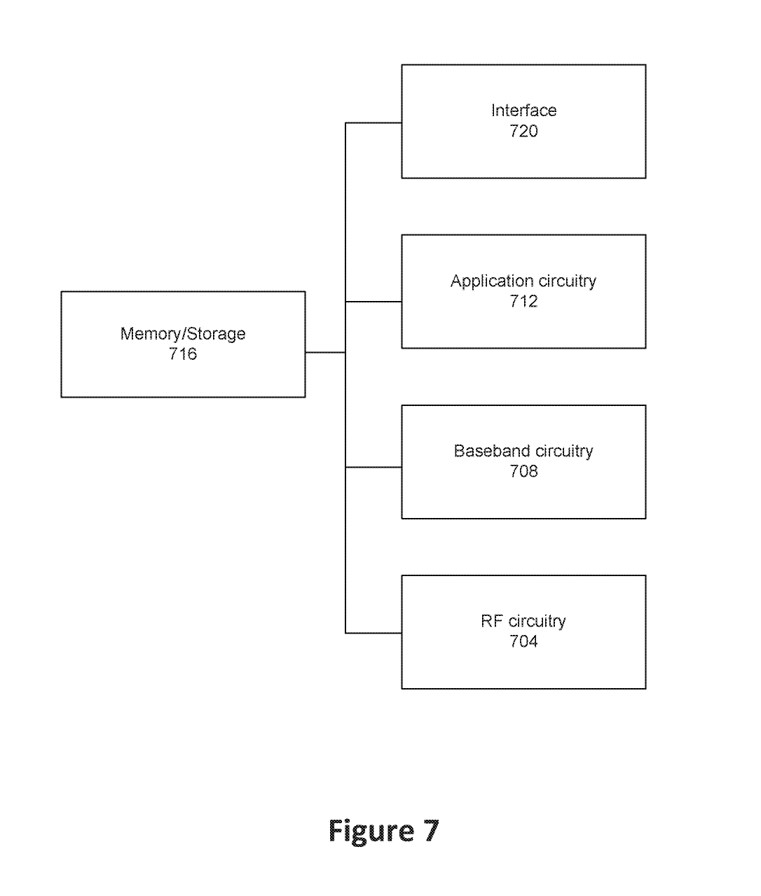

Embodiments described herein may be implemented into a system using any suitably configured hardware and/or software. FIG. 7 illustrates, for one embodiment, an example system comprising radio frequency (RF) circuitry 704, baseband circuitry 708, application circuitry 712, memory/storage 716, and interface circuitry 720, coupled with each other at least as shown.

The application circuitry 712 may include circuitry such as, but not limited to, one or more single-core or multi-core processors. The processor(s) may include any combination of general-purpose processors and dedicated processors (e.g., graphics processors, application processors, etc.). The processors may be coupled with memory/storage 716 and configured to execute instructions stored in the memory/storage 716 to enable various applications and/or operating systems running on the system.

The baseband circuitry 708 may include circuitry such as, but not limited to, one or more single-core or multi-core processors. The processor(s) may include a baseband processor. The baseband circuitry 708 may handle various radio control functions that enable communication with one or more radio networks via the RF circuitry 704. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry 708 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 708 is configured to support radio communications of more than one wireless protocol may be referred to as multi-mode baseband circuitry.

In various embodiments, baseband circuitry 708 may include circuitry to operate with signals that are not strictly considered as being in a baseband frequency. For example, in some embodiments, baseband circuitry 708 may include circuitry to operate with signals having an intermediate frequency, which is between a baseband frequency and a radio frequency.

RF circuitry 704 may enable communication with wireless networks using modulated electromagnetic radiation through a non-solid medium. In various embodiments, the RF circuitry 704 may include switches, filters, amplifiers, etc. to facilitate the communication with the wireless network.

In various embodiments, RF circuitry 704 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the radio circuitry and control circuitry discussed herein with respect to the relay node or eNB may be embodied in whole or in part in one or more of the RF circuitry 704, the baseband circuitry 708, and/or the application circuitry 712.

In some embodiments, some or all of the constituent components of the baseband circuitry 708, the application circuitry 712, and/or the memory/storage 716 may be implemented together on a system on a chip (SOC).

Memory/storage 716 may be used to load and store data and/or instructions, for example, for the system. Memory/storage 716 for one embodiment may include any combination of suitable volatile memory (e.g., dynamic random access memory (DRAM)) and/or non-volatile memory (e.g., Flash memory).

In various embodiments, the interface circuitry 720 may include one or more user interfaces designed to enable user interaction with the system and/or peripheral component interfaces designed to enable peripheral component interaction with the system.

In various embodiments, the interface circuitry 720 may be a network interface that has circuitry to communicate with one or more other network technologies. For example, the interface circuitry 720 may be capable of communicating over Ethernet or other computer networking technologies using a variety of physical media interfaces such as, but not limited to, coaxial, twisted-pair, and fiber-optic media interfaces.

In various embodiments, the system may have more or fewer components, and/or different architectures.

Some non-limiting examples are provided below.

Example 1 includes one or more computer-readable media having instructions that, when executed, cause an eNB to: establish a primary cell (PCell) in a mobile broadband spectrum to communicate with a first relay node; transmit, via the PCell, a discovery signal message that includes configuration information of millimeter wave (mmWave) discovery signals that are to be transmitted by one or more additional relay nodes and a request for measurement information corresponding to the mmWave discovery signals; receive, via the PCell, a measurement report from the first relay node that includes measurement information that corresponds to mmWave discovery signals; and select a second relay node, based on the measurement report, to provide a mmWave secondary cell (SCell) for the first relay node.

Example 2 includes the one or more computer-readable media of example 1, wherein the instructions, when executed, further cause the eNB to: transmit a radio resource control message to the first relay node to configure the mmWave SCell.

Example 3 includes the one or more computer-readable media of example 1, wherein the measurement report includes a sequence identifier and a beam identifier and the instructions, when executed, further cause the eNB to: transmit, to the second relay node, a radio resource control (RRC) context of the first relay node that includes the sequence identifier and the beam identifier.

Example 4 includes the one or more computer-readable media of example 1, wherein the instructions, when executed, further cause the eNB to: receive, discovery signal capability message from the first relay node that includes an indication of a number of parallel and sequential mmWave discovery signals the first relay node is capable of transmitting.

Example 5 includes the one or more computer-readable media of example 4, wherein the instructions, when executed, further cause the eNB to: transmit discovery signal capability confirmation to the first relay node, the discovery signal capability confirmation to include an indication of a hop region in which the first relay node is to transmit mmWave discovery signals.

Example 6 includes the one or more computer-readable media of any one of examples 1-5, wherein the instructions, when executed, further cause the eNB to: transmit, to the second relay node, a request for measurement information corresponding to a discovery signal of the first relay node; receive, a measurement report from the second relay node, that includes a sequence identifier and a beam identifier; select a transmit beam direction for transmissions from the first relay node to the second relay node; and transmit an indication of the transmit beam direction to the first relay node.

Example 7 includes the one or more computer-readable media of example 1, wherein the mmWave SCell is a first mmWave Scell and the instructions, when executed, further cause the eNB to: select a third relay node, based on the measurement report, to provide a second mmWave SCell for the first relay node.

Example 8 includes an apparatus to provide a user access cell, the apparatus comprising: first radio circuitry to communicate in a mobile broadband spectrum; second radio circuitry to communicate in a millimeter wave (mmWave) spectrum; and control circuitry coupled with the first radio circuitry and the second radio circuitry, the control circuitry to: receive, via the first radio circuitry from an enhanced node B (eNB) through a primary cell (PCell) provided by the eNB, a discovery signal message that includes configuration information of mmWave discovery signals that are to be transmitted by one or more relay nodes within a coverage area of the eNB and a request for measurement information corresponding to the mmWave discovery signals; control the second radio circuitry to measure mmWave discovery signals based on the configuration information; and transmit, via the first radio circuitry, a measurement report that includes measurement information corresponding to the mmWave discovery signals to the eNB.

Example 9 includes the apparatus of example 8, wherein the control circuitry is further to receive, via the first radio circuitry, a radio resource control message that includes configuration information of an mmWave SCell to be provided to the apparatus by a relay node of the one or more relay nodes.

Example 10 includes the apparatus of example 9, wherein the control circuitry is to control the first radio circuitry to monitor a control channel of the PCell and to control the second radio circuitry to monitor control channel of the SCell.

Example 11 includes the apparatus of example 9, wherein the control circuitry is to transmit, via the first radio circuitry, discovery signal capability information that includes a number of parallel and sequential mmWave discovery signals that the second radio circuitry is capable of transmitting.

Example 12 includes the apparatus of example 11, wherein the control circuitry is to receive, via the first radio circuitry from the eNB, discovery signal capability confirmation that includes an indication of a hop region in which the apparatus is to transmit mmWave discovery signals.

Example 13 includes the apparatus of any one of examples 8-12, wherein the second radio circuitry comprises one or more radio frequency (RF) beam formers and the second radio circuitry is to transmit mmWave discovery signals in one or more discovery clusters that respectively correspond to the one or more radio frequency beam formers.

Example 14 includes the apparatus of example 13, wherein the one or more discovery clusters overlap in time.

Example 15 includes the apparatus of example 13, wherein a first RF beam former is to transmit a plurality of mmWave discovery signals in a corresponding plurality of discovery occasions in a discovery cluster with each of the plurality of mmWave discovery signals transmitted in a different beam direction.

Example 16 includes the apparatus of example 13, wherein the one or more discovery clusters occur in a hop discovery region indicated by the eNB.

Example 17 includes the apparatus of any one of examples 8-16, wherein the control circuitry is to: receive, via the first radio circuitry, an indication of a transmit beam configuration; and transmit, via the second radio circuitry, uplink data through the SCell based on the transmit beam configuration.

Example 18 includes one or more computer-readable media having instructions that, when executed, cause a first relay node to: receive, from an evolved node B (eNB) through a primary cell (PCell) in a mobile broadband spectrum, radio resource control (RRC) context of a second relay node, the RRC context to include an indication of a preferred sector and beam; schedule and transmit data to the second relay node using millimeter wave (mmWave) signals using the preferred sector and beam.

Example 19 includes the one or more computer-readable media of example 18, wherein the instructions, when executed, further cause the first relay node to: provide a secondary cell (SCell) for the second relay node; and transmit the data through the SCell.

Example 20 includes the one or more computer-readable media of example 18 or 19, wherein the instructions, when executed, further cause the first relay node to: receive a measurement request from the eNB; measure mmWave discovery signals from the second relay node based on the measurement request; and transmit, to the eNB, a measurement report that includes an indication of a sequence and beam.

Example 21 includes the one or more computer-readable media of example 20, wherein the indication of the sequence and beam include a sequence identifier and the beam identifier.

Example 22 includes an apparatus comprising: first radio circuitry; second radio circuitry to communicate using millimeter wave (mmWave) spectrum; and control circuitry to: control the first radio circuitry to provide a primary cell (PCell) in a mobile broadband spectrum to communicate with a first relay node; transmit, via the PCell, a discovery signal message that includes configuration information of mmWave discovery signals that are to be transmitted by one or more additional relay nodes and request for measurement information corresponding to the mmWave discovery signals; receive, via the PCell, a measurement report from the first relay node that includes measurement information that corresponds to mmWave discovery signals; and select a second relay node, based on the measurement report, to provide a mmWave secondary cell (SCell) for the first relay node.

Example 23 includes the apparatus of example 22, wherein the control circuitry is further to cause the first radio circuitry to transmit a radio resource control message to the first relay node to configure the mmWave SCell.

Example 24 includes the apparatus of example 22, wherein the measurement report includes a sequence identifier and a beam identifier and the control circuitry is further to: control the first radio circuitry to transmit, to the second relay node, a radio resource control (RRC) context of the first relay node that includes the sequence identifier and the beam identifier.

Example 25 includes the apparatus of example 22, wherein the second radio circuitry is to receive, discovery signal capability message from the first relay node that includes an indication of a number of parallel and sequential mmWave discovery signals the first relay node is capable of transmitting.

Example 26 includes the apparatus of example 25, wherein the control circuitry is further to control the first radio circuitry to: transmit discovery signal capability confirmation to the first relay node, the discovery signal capability confirmation to include an indication of a hop region in which the first relay node is to transmit mmWave discovery signals.

Example 27 includes the apparatus of example 22, wherein: the second radio circuitry is to transmit, to the second relay node, a request for measurement information corresponding to a discovery signal of the first relay node, and receive, a measurement report from the second relay node, that includes a sequence identifier and a beam identifier; the control circuitry is to select a transmit beam direction for transmissions from the first relay node to the second relay node, and to control the second radio circuitry to transmit an indication of the transmit beam direction to the first relay node.

Example 28 includes the apparatus of example 22, wherein the mmWave SCell is a first mmWave SCell and the control circuitry is to: select a third relay node, based on the measurement report, to provide a second mmWave SCell for the first relay node.

Example 29 includes a method of operating a relay node in a cellular network, the method comprising: transmitting, to an anchor evolved node B (eNB), an authentication message over a radio resource control (RRC) connection to authenticate the relay node in the cellular network, the relay node to provide a millimeter wave (mmWave) connection; processing a response, received from the anchor eNB, related to the authentication message; and processing an RRC message received from the anchor eNB after receipt of the response in a cellular spectrum below 6 gigahertz (GHz).

Example 30 includes the method of example 29, wherein the anchor eNB is to provide a primary cell (PCell) of the cellular network to support communication with the relay node.

Example 31 includes the method of example 29, wherein the authentication message is to a mobility management entity (MME) of the cellular network.

Example 32 includes the method of example 29, wherein the RRC message is scheduled in a physical downlink control channel (PDCCH) or an enhanced PDCCH (e-PDCCH).

Example 33 includes the method of any one of examples 29-32, wherein the relay node is a first relay node, the mmWave cell is a first mmWave cell, and the method further comprises: processing an mmWave discovery signal received from a second relay node that is to provide a second mmWave cell; measuring a received power or received quality of the mmWave discovery signal; and reporting an indication of the measurement of the received power or received quality to the anchor eNB.

Example 34 includes the method of example 33, further comprising: reporting the indication based on a periodic reporting event or a request from the anchor eNB.

Example 35 includes the method of example 33, further comprising: processing a discovery signal message from the anchor eNB; and detecting the mmWave discovery signal based on the discovery signal message.

Example 36 includes the method comprising: receiving, from an enhanced node B (eNB) through a primary cell (PCell) provided by the eNB, a discovery signal message that includes configuration information of mmWave discovery signals that are to be transmitted by one or more relay nodes within a coverage area of the eNB and a request for measurement information corresponding to the mmWave discovery signals; measuring mmWave discovery signals based on the configuration information; and transmitting a measurement report that includes measurement information corresponding to the mmWave discovery signals to the eNB.

Example 37 includes the method of example 36, further comprising: receiving a radio resource control message that includes configuration information of an mmWave SCell to be provided by a relay node of the one or more relay nodes.

Example 38 includes the method of example 36, further comprising: monitoring a control channel of the PCell and the SCell.

Example 39 includes the method of example 36, further comprising: transmitting, to the eNB, discovery signal capability information that includes a number of parallel and sequential mmWave discovery signals that a relay node is capable of transmitting.

Example 40 includes the method of example 39, further comprising: receiving, from the eNB, discovery signal capability confirmation that includes an indication of a hop region in which the apparatus is to transmit mmWave discovery signals.

Example 41 includes the method of any one of examples 36-39, further comprising: transmitting mmWave discovery signals in one or more discovery clusters that respectively correspond to one or more radio frequency beam formers.

Example 42 includes the method of example 41, wherein the one or more discovery clusters overlap in time.

Example 43 includes the method of example 41, wherein a first RF beam former is to transmit a plurality of mmWave discovery signals in a corresponding plurality of discovery occasions in a discovery cluster with each of the plurality of mmWave discovery signals transmitted in a different beam direction.

Example 44 includes the method of example 41, wherein the one or more discovery clusters occur in a hop discovery region indicated by the eNB.

The example 45 includes the method of any one of examples 36-44, further comprising: receiving an indication of a transmit beam configuration; and transmitting uplink data through the SCell based on the transmit beam configuration.

Example 46 includes a method of operating a first relay node comprising: receiving, from an evolved node B (eNB) through a primary cell (PCell) in a mobile broadband spectrum, radio resource control (RRC) context of a second relay node, the RRC context to include an indication of a preferred sector and beam; scheduling and transmitting data to the second relay node using millimeter wave (mmWave) signals using the preferred sector and beam.

Example 47 includes the method of example 46, further comprising providing a secondary cell (SCell) for the second relay node; and transmitting the data through the SCell.

Example 48 includes the method of example 46 or 47 further comprising: receiving a measurement request from the eNB; measuring mmWave discovery signals from the second relay node based on the measurement request; and transmitting, to the eNB, a measurement report that includes an indication of a sequence and beam.

Example 49 includes the method of example 48, wherein the indication of the sequence and beam includes a sequence identifier and a beam identifier.

Example 50 includes a method of operating a relay node comprising: applying long term evolution (LTE) user equipment (UE) functionality to establish a radio resource control (RRC) connection with an evolved nodeB (eNB) serving as a primary cell (PCell) for the relay node; accomplishing an mmWave small cell node authentication with a mobility management entity (MME) through the eNB; monitoring a physical downlink control channel (PDCCH) or enhanced PDCCH (E-PDCCH) transmitted from the eNB in a cellular spectrum below 6 Gigahertz (6 GHz); and demodulating and decoding RRC signaling transmitted from the eNB in the conventional cellular spectrum below 6 GHz.

Example 51 includes a method of operating an evolved node B (eNB) comprising: serving as a primary cell (PCell) for a relay node; configuring receive discovery signals to the relay node; configuring a millimeter wave (mmWave) secondary cell for the relay node; and routing backhaul link traffic to the relay node.

Example 52 includes a method comprising: transmitting, by a relay node in a cellular network to an anchor evolved node B (eNB) in the cellular network, an authentication message over a radio resource control (RRC) connection, the authentication message related to millimeter-wave (mmWave) small cell node authentication;
receiving, by the relay node from the anchor eNB, a response related to the authentication message; and receiving, by the relay node from the anchor eNB after receiving the response related to the authentication message, a radio resource control (RRC) message in a cellular spectrum below 6 Gigahertz (6 GHz).

Example 53 includes a method comprising: transmitting, by an evolved node B (eNB) in a cellular network that serves as a primary cell (PCell) for a relay node and is configured to transmit millimeter-wave (mmWave) signals, an indication of a configuration of receive discovery signals to the relay node; transmitting, by the eNB, an indication of a configuration of mmWave secondary cells (SCells) to the relay node; and routing, by the eNB, backhaul link traffic to the relay node.

Example 54 includes a method comprising: receiving, by a first relay node in a cellular network, a message from an evolved node B (eNB) including a preferred sector identifier (ID) or a beam direction ID for downlink (DL) traffic to a second relay node; transmitting, by the first relay node, the DL traffic to the second relay node according to the preferred sector ID or beam direction ID; receiving, by the first relay node in the cellular network from the second relay node in the cellular network, a discovery signal related to a millimeter-wave (mmWave) transmission of the second relay node; identifying, by the first relay node, a discovery signal receive power or discovery signal receive quality related to the discovery signal; and transmitting, by the first relay node, an indication of the identified discovery signal receive power or discovery signal receive quality to the eNB of the cellular network.

Example 55 includes one or more computer-readable media having instructions that, when executed, cause a device to perform any one of the methods of examples 29-54.

Example 56 includes an apparatus comprising means to perform any one of the methods of examples 29-54.

The description herein of illustrated implementations, including what is described in the Abstract, is not intended to be exhaustive or to limit the present disclosure to the precise forms disclosed. While specific implementations and examples are described herein for illustrative purposes, various equivalent modifications are possible within the scope of the disclosure, as those skilled in the relevant art will recognize. These modifications may be made to the disclosure in light of the above detailed description.

1. One or more non-transitory, computer-readable media having instructions that, when executed, cause an eNB to:
establish a primary cell (PCell) in a mobile broadband spectrum to communicate with a first relay node;
transmit, via the PCell, a discovery signal message that includes configuration information of millimeter wave (mmWave) discovery signals that are to be transmitted by one or more additional relay nodes and a request for measurement information corresponding to the mmWave discovery signals;
receive, via the PCell, a measurement report from the first relay node that includes measurement information that corresponds to mmWave discovery signals; and
select a second relay node, based on the measurement report, to provide a mmWave secondary cell (SCell) for the first relay node.

2. The one or more non-transitory, computer-readable media of claim 1, wherein the instructions, when executed, further cause the eNB to:
transmit a radio resource control message to the first relay node to configure the mmWave SCell.

3. The one or more non-transitory, computer-readable media of claim 1, wherein the measurement report includes a sequence identifier and a beam identifier and the instructions, when executed, further cause the eNB to:
transmit, to the second relay node, a radio resource control (RRC) context of the first relay node that includes the sequence identifier and the beam identifier.

4. The one or more non-transitory, computer-readable media of claim 1, wherein the instructions, when executed, further cause the eNB to:
receive, discovery signal capability message from the first relay node that includes an indication of a number of parallel and sequential mmWave discovery signals the first relay node is capable of transmitting.

5. The one or more non-transitory, computer-readable media of claim 4, wherein the instructions, when executed, further cause the eNB to:
transmit discovery signal capability confirmation to the first relay node, the discovery signal capability confirmation to include an indication of a hop region in which the first relay node is to transmit mmWave discovery signals.

6. The one or more non-transitory, computer-readable media of claim 1, wherein the instructions, when executed, further cause the eNB to:
transmit, to the second relay node, a request for measurement information corresponding to a discovery signal of the first relay node;
receive, a measurement report from the second relay node, that includes a sequence identifier and a beam identifier;
select a transmit beam direction for transmissions from the first relay node to the second relay node; and
transmit an indication of the transmit beam direction to the first relay node.

7. The one or more computer-readable media of claim 1, wherein the mmWave SCell is a first mmWave Scell and the instructions, when executed, further cause the eNB to:
select a third relay node, based on the measurement report, to provide a second mmWave SCell for the first relay node.

8. An apparatus to provide a user access cell, the apparatus comprising:
first radio circuitry to communicate in a mobile broadband spectrum;
second radio circuitry to communicate in a millimeter wave (mmWave) spectrum; and
control circuitry coupled with the first radio circuitry and the second radio circuitry, the control circuitry to:
receive, via the first radio circuitry from an enhanced node B (eNB) through a primary cell (PCell) provided by the eNB, a discovery signal message that includes configuration information of mmWave discovery signals that are to be transmitted by one or more relay nodes within a coverage area of the eNB and a request for measurement information corresponding to the mmWave discovery signals;
control the second radio circuitry to measure mmWave discovery signals based on the configuration information; and
transmit, via the first radio circuitry, a measurement report that includes measurement information corresponding to the mmWave discovery signals to the eNB.

9. The apparatus of claim 8, wherein the control circuitry is further to receive, via the first radio circuitry, a radio resource control message that includes configuration information of an mmWave SCell to be provided to the apparatus by a relay node of the one or more relay nodes.

10. The apparatus of claim 9, wherein the control circuitry is to control the first radio circuitry to monitor a control channel of the PCell and to control the second radio circuitry to monitor control channel of the SCell.

11. The apparatus of claim 9, wherein the control circuitry is to transmit, via the first radio circuitry, discovery signal capability information that includes a number of parallel and sequential mmWave discovery signals that the second radio circuitry is capable of transmitting.

12. The apparatus of claim 11, wherein the control circuitry is to receive, via the first radio circuitry from the eNB, discovery signal capability confirmation that includes an indication of a hop region in which the apparatus is to transmit mmWave discovery signals.

13. The apparatus of claim 8 wherein the second radio circuitry comprises one or more radio frequency (RF) beam formers and the second radio circuitry is to transmit mmWave discovery signals in one or more discovery clusters that respectively correspond to the one or more radio frequency beam formers.

14. The apparatus of claim 13, wherein the one or more discovery clusters overlap in time.

15. The apparatus of claim 13, wherein a first RF beam former is to transmit a plurality of mmWave discovery signals in a corresponding plurality of discovery occasions in a discovery cluster with each of the plurality of mmWave discovery signals transmitted in a different beam direction.

16. The apparatus of claim 13, wherein the one or more discovery clusters occur in a hop discovery region indicated by the eNB.

17. The apparatus of claim 8 wherein the control circuitry is to:
receive, via the first radio circuitry, an indication of a transmit beam configuration; an
transmit, via the second radio circuitry, uplink data through the SCell based on the transmit beam configuration.

18. One or more non-transitory, computer-readable media having instructions that, when executed, cause a first relay node to:
receive, from an evolved node B (eNB) through a primary cell (PCell) in a mobile broadband spectrum, radio resource control (RRC) context of a second relay node, the RRC context to include an indication of a preferred sector and beam;
schedule and transmit data to the second relay node using millimeter wave (mmWave) signals using the preferred sector and beam.

19. The one or more non-transitory, computer-readable media of claim 18, wherein the instructions, when executed, further cause the first relay node to:
provide a secondary cell (SCell) for the second relay node; and
transmit the data through the SCell.

20. The one or more non-transitory, computer-readable media of claim 18, wherein the instructions, when executed, further cause the first relay node to:
receive a measurement request from the eNB;
measure mmWave discovery signals from the second relay node based on the measurement request; and
transmit, to the eNB, a measurement report that includes an indication of a sequence and beam.

21. The one or more non-transitory, computer-readable media of claim 20, wherein the indication of the sequence and beam include a sequence identifier and the beam identifier.

22. An apparatus comprising:
first radio circuitry;
second radio circuitry to communicate using millimeter wave (mmWave) spectrum; and
control circuitry to:
control the first radio circuitry to provide a primary cell (PCell) in a mobile broadband spectrum to communicate with a first relay node;
transmit, via the PCell, a discovery signal message that includes configuration information of mmWave discovery signals that are to be transmitted by one or more additional relay nodes and request for measurement information corresponding to the mmWave discovery signals;
receive, via the PCell, a measurement report from the first relay node that includes measurement information that corresponds to mmWave discovery signals; and
select a second relay node, based on the measurement report, to provide a mmWave secondary cell (SCell) for the first relay node.

23. The apparatus of claim 22, wherein the control circuitry is further to cause the first radio circuitry to transmit a radio resource control message to the first relay node to configure the mmWave SCell.

24. The apparatus of claim 22, wherein the measurement report includes a sequence identifier and a beam identifier and the control circuitry is further to:
control the first radio circuitry to transmit, to the second relay node, a radio resource control (RRC) context of the first relay node that includes the sequence identifier and the beam identifier.

25. The apparatus of claim 22, wherein the second radio circuitry is to receive, discovery signal capability message from the first relay node that includes an indication of a number of parallel and sequential mmWave discovery signals the first relay node is capable of transmitting.
